(19) United States
(12) Patent Application Publication
(10) Pub. No.: US 2009/0265995 A1
(43) Pub. Date: Oct. 29, 2009

(54) Door Leaf

(76) Inventor: Johann Bramauer, Ybbsitz (AT)

Correspondence Address: BARNES & THORNBURG LLP, 750-17TH STREET NW, SUITE 900, WASHINGTON, DC, 20006-4675, US

(21) Appl. No.: 11/989,727

(22) PCT Filed: Jul. 31, 2006
(86) PCT No.: PCT/EP2006/007563

§ 371 Date: Feb. 3, 2009

(30) Foreign Application Priority Data
Aug. 1, 2005 (AT) A 1292/2005

(51) Int. Cl. B60J 5/06

(52) U.S. Cl. 49/380

(57) ABSTRACT

A door leaf for external sliding doors of railway cars. The door leaf includes a frame and at least one partially transparent panel.

### BACKGROUND AND SUMMARY

The present disclosure relates to a door leaf for external sliding doors of passenger cars, high speed railroad cars and subway cars, hereinafter collectively referred to as vehicles. The sliding doors include a frame and a panel which is made of glass or at least partially transparent plastic and is, if appropriate, of multi-component design.

In this context, external is to be understood as meaning that the doors are sliding doors via which the train can be entered from the outside, and the term does not refer to the spatial position of the sliding door in the opened state. Such sliding doors or their door wings can, as in most cases, be pushed in the opened state along the external wall of the train. The doors continue to be visible from the outside or else, for example, can also disappear during the opening process in the interior of an external wall which is of hollow design.

Such door leaves, with surfaces which are embodied “with a single layer”, may be made of glass or transparent plastic. In the text which follows, for the sake of better comprehensibility, only the term glass is used. Such door leaves are provided on the inside with a frame in order to ensure the necessary mechanical stability and have been known for some time. The glass panel can be embodied here in one piece or divided. In the text which follows, for the sake of better comprehensibility the glass panel is mentioned only in the singular. A disadvantage with this door is the uneven design, which is provided as a result of the frame and which, particularly during the opening of the door, leads to the risk of a person's fingers or objects becoming trapped in the region of the door frame.

Generally, door leaves, to which an entire series of activation devices, mounts and coupling points for the door drive and door guides have to be attached, have been known for a long time. In order to make these door leaves visually appealing and functional, they have had glazed regions since their beginnings over 150 years ago. In the last few years, spot welding of the metal frames, which was customary earlier, has been dispensed with in favor of bonding technology. The surface coating has been changed to an environmentally friendly, water-soluble surface coating. Various control lines for sensors, i.e., trapping prevention means, activation elements and lighting systems etc. have been laid between the two metal surfaces, or planking, which bound the door leaves on the inside and outside. In addition, thermal and sound insulating materials have been arranged and the windows have not only been fabricated from safety glass but also from thermally and acoustically insulating material, in a suitable design to increase the comfort of the passengers and save energy.

The present disclosure relates to a door leaf which does not have the aforesaid disadvantages and which meets the optical and functional requirements at least as much as the door leaves according to the prior art.

According to the present disclosure, the glass panel is arranged on the inside of the profiles which form the frame. As a result, a completely planar surface is obtained in the interior of the vehicle, the surface eliminating as well as possible the risk of trapping. On the outside, a surface is obtained which is significantly better aligned with the surface of the surrounding railroad car body than in the case of doors according to the prior art. This significantly improves the visual appearance.

The term “planar” is not be understood as planar in the mathematical sense over the entire surface of the door leaf. The door leaf can of course, as in the prior art, be adapted to the cross-sectional shape of the railroad car body. Planar means that the unavoidable local and often relatively hard transitions at the junction between the glass and the frame in the prior art are eliminated or are moved to the outside of the railroad car.

Other aspects of the present disclosure will become apparent from the following descriptions when considered in conjunction with the accompanying drawings.

### BRIEF DESCRIPTION OF THE DRAWINGS

FIG. 1 is a schematic view of an interior of a two-wing door, according to the present disclosure.

FIG. 2 is a view of a section along the line II-II of FIG. 1.

FIG. 3 is a schematic view of FIG. 1.

### DETAILED DESCRIPTION

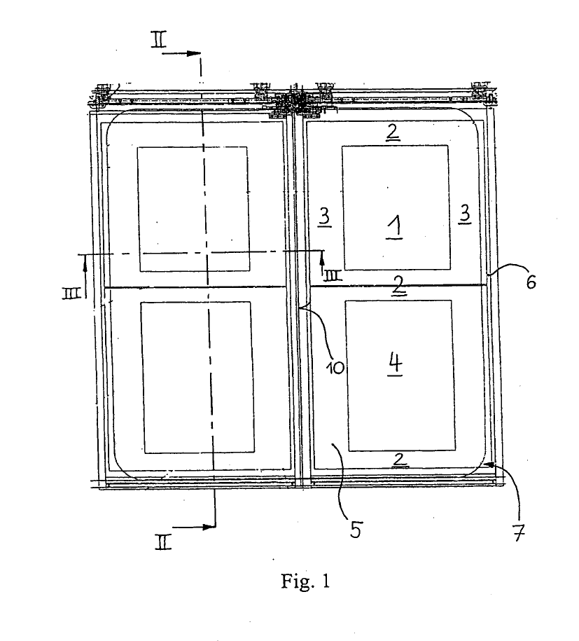

As is shown in FIG. 1, door leaf or door wing 1, for vehicles, which vehicles may include passenger cars, high-speed railroad cars, and subway cars, according to the present disclosure, includes three horizontally extending profiles 2 and two vertically extending profiles 3. It is within the scope of the present disclosure that more than three horizontally extending profiles 2 are also conceivable. Profiles 2, 3 can have the same cross section as one another, or else may not have the same cross section. Profiles 2, 3 may be cut at their comers or in a central region where they meet with a mitered joint. This may depend on the profile used and a location or guidance of cables or lines, and can be selected by a person skilled in the art and having knowledge of the present disclosure.

On an inside of a frame 5, which is formed by the profiles 2, 3, a glass panel 4 is bonded. Glass panel 4 can be divided, as shown in FIG. 1, in the horizontal direction in the region of the central horizontal profile 2 in order, during mounting, to reduce the weight of the individual panels and to simplify repair in the case of a fracture. The panel or pane 4 may be rounded at corners 7 in a region of a secondary closing edge 6.

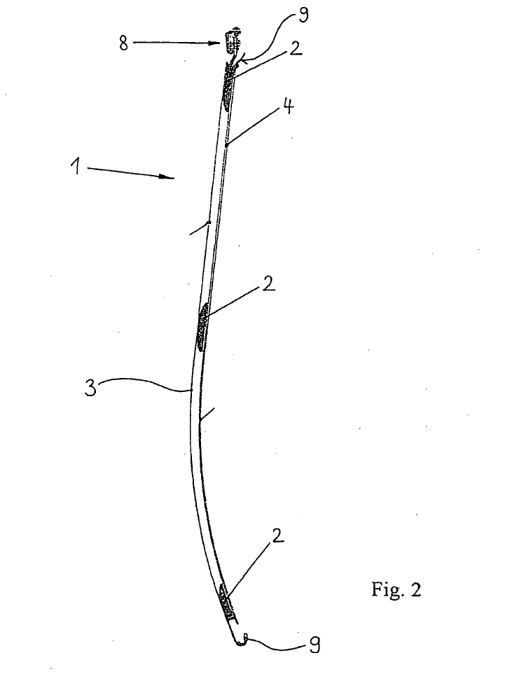

As shown in FIG. 2, it is possible, as is the case with subway fittings, for the door leaves or wings 1 to be in the form of a general cylinder and to be of bent design in a vertical section. This does not constitute a problem for glass or for plastic. As suggested in FIG. 2, upper transverse or horizontally-extending profile 2 can be used as an attachment point for a suspension means 8 of the door leaf or wing 1 and that the profiles 2 which are located at an external edge are provided with sealing devices 9.

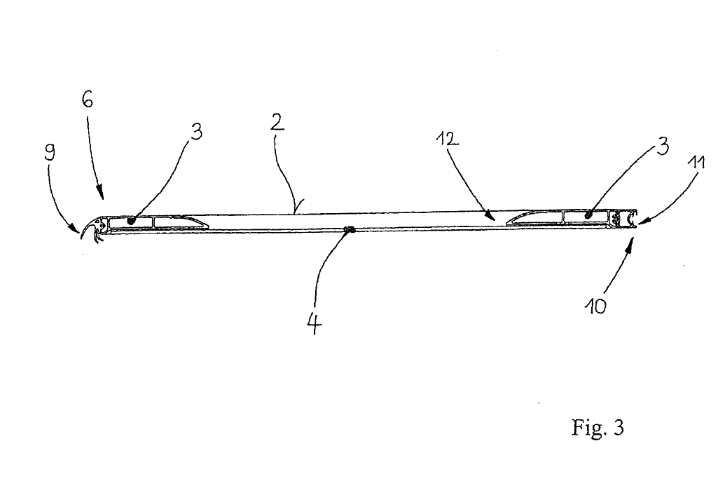

FIG. 3 shows the vertical profiles 3, and in a region of the secondary closing edge 6, a sealing profile 9. In a region of a main closing edge 10, sealing profile 9 is also embodied as a finger protection 11. The door leaf 1, not shown in FIG. 3, is symmetrical thereto. Or in the case of a single-wing door, the door leaf 1 is symmetrical to the main closing edge 10 on the door frame. The door leaf 1 has a correspondingly congruent profile.

As shown in FIG. 3, arrow 12 points to one of the edges which lie on the inside of the doors, according to the prior art, and form the trapping risk there. Since, according to the present disclosure, these edges are formed on the outside, this risk is eliminated. As is also clear, the thickness of the profiles 2, 3 decreases with a slope on their inner side, that is, the side facing the center of the door surface. This facilitates automatic cleaning of the outside and damps the travel noise due to elimination of the customary sharp edge.

Although the present disclosure has been described and illustrated in detail, it is to be clearly understood that this is done by way of illustration and example only and is not to be taken by way of limitation. The scope of the present disclosure is to be limited only by the terms of the appended claims.

1. A door leaf for external sliding doors of passenger cars, high speed railroad cars and subway cars which are composed of a frame (5) and an at least partially transparent panel (4) made of glass or plastic which is, if appropriate, of multi-component design, characterized in that the panel (4) is arranged on the inside of the frame (5).

2. The door leaf as claimed in claim 1, characterized in that the frame (5) is composed of profiles (2, 3) whose thickness decreases successively towards the center of the surface of the door leaf.

3. The door leaf as claimed in claim 1 or 2, characterized in that its suspension means (8) and guides engage on the frame (5).
